(19) United States
(12) Patent Application Publication
(10) Pub. No.: US 2026/0280065 A1
(43) Pub. Date: Sep. 17, 2026

(54) ELECTRODE SHEET, WINDING CORE, CYLINDRICAL BATTERY, AND BATTERY PACK

(71) Applicant: EVE ENERGY CO., LTD., Huizhou (CN)

(72) Inventors: Leixin DENG, Huizhou (CN); Chao LIU, Huizhou (CN); Yuefei LI, Huizhou (CN); Pengyuan SONG, Huizhou (CN)

(73) Assignee: EVE ENERGY CO., LTD., Huizhou (CN)

(21) Appl. No.: 19/669,961

(22) Filed: May 6, 2026

Related U.S. Application Data
(63) Continuation of application No. PCT/CN2024/105739, filed on Jul. 16, 2024.

(30) Foreign Application Priority Data
May 28, 2024 (CN) 202410674912.0

(51) Int. Cl. H01M 50/533; H01M 50/107

(52) U.S. Cl. CPC H01M 50/533; H01M 50/107

(57) ABSTRACT

The present application provides an electrode sheet, a winding core, a cylindrical battery, and a battery pack. A plurality of tabs are provided at one side of the electrode sheet at intervals. The electrode sheet includes at least two segments in a first direction. Each segment of the at least two segments has at least one tab. A length of the tab in the first direction defines a width of the tab, a length of the tab in a second direction perpendicular to the first direction is a height of the tab. For the at least one tab located in the same segment, the tab has uniform width and height. For tabs respectively located in different segments, the tabs have different widths or different heights.

### CROSS REFERENCE TO RELATED APPLICATIONS

This application is a U.S. bypass continuation of International Application No. PCT/CN2024/105739, filed on Jul. 16, 2024, which claims priority to Chinese Application No. 202410674912.0, filed on May 28, 2024. The entire contents of each of the above-referenced applications are expressly incorporated herein by reference.

### TECHNICAL FIELD

The present disclosure relates to the field of battery technologies, and particularly to an electrode sheet, a winding core, a cylindrical battery, and a battery pack.

### BACKGROUND

In the related art, a tab of a winding core of a cylindrical battery generally needs to be flattened or roller leveled, thereby achieving the effects of flattening an end portion, preventing scratching of an inner wall of a battery case, collecting current, preventing short circuit, and the like.

However, in a process of roller leveling or flattening the tab of the winding core of the cylindrical battery, the tab is prone to overlapping, misalignment, and the like, resulting in defects such as a cavity or deformation of the tab.

### SUMMARY

The present disclosure provides an electrode sheet. A plurality of tabs are provided at one side of the electrode sheet at intervals, and the electrode sheet includes at least two segments in a first direction, each segment having at least one of the plurality of tabs, a length of the tab in the first direction indicating a width of the tab, a length of the tab in a second direction indicating a height of the tab, and the second direction being perpendicular to the first direction, where for the at least one tab located in the same segment, the tab has the same width and the same height, and for the tabs respectively located in different segments, the tabs have different widths and/or different heights (i.e., at least one of different widths or different heights).

The present disclosure further provides a winding core. The winding core is formed by winding the electrode sheet as previously described. The first direction is a direction in which the electrode sheet is wound.

The present disclosure further provides a cylindrical battery. The cylindrical battery includes the winding core as previously described.

The present disclosure further provides a battery pack. The battery pack includes the cylindrical battery as previously described.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the disclosure.

FIG. 1 is a schematic structural diagram of an exemplary electrode sheet according to some embodiments of the present disclosure.

FIG. 2 is a schematic structural diagram of an exemplary electrode sheet according to some embodiments of the present disclosure.

FIG. 3 is a schematic structural diagram of an exemplary electrode sheet according to some embodiments of the present disclosure.

FIG. 4 is a schematic structural diagram of an exemplary electrode sheet according to some embodiments of the present disclosure.

FIG. 5 is a schematic structural diagram of an exemplary electrode sheet according to some embodiments of the present disclosure.

FIG. 6 is a schematic structural diagram of an exemplary electrode sheet according to some embodiments of the present disclosure.

FIG. 7 is a schematic structural diagram of an exemplary electrode sheet according to some embodiments of the present disclosure.

FIG. 8 is a schematic structural diagram of an exemplary electrode sheet according to some embodiments of the present disclosure.

### REFERENCE NUMERALS

10. Electrode sheet; 20. Tab; 30. Segment; 40. Beveled edge.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented.

An embodiment of the present disclosure provides an electrode sheet 10. The electrode sheet 10 is wound to form a winding core. A plurality of tabs 20 are provided at one side of the electrode sheet 10 at intervals. The electrode sheet 10 includes at least two segments 30 in a first direction. Each segment 30 of the at least two segments 30 has at least one tab 20 of the plurality of tabs 20. A length of the tab 20 in the first direction is a width of the tab 20, and a length of the tab 20 in a second direction is a height of the tab 20. Where for the at least one tab 20 located in the same segment 30, the tab 20 has the same width and the same height. For the tabs 20 respectively located in different segments 30, the tabs 20 have different widths and/or different heights.

In the present embodiment, the electrode sheet 10 is divided into the plurality of segments 30, so that the tabs 20 in the same segment 30 have the same width and the same height and the tabs 20 in different segments 30 have different widths and/or different heights. Based on different designs of the widths and the heights of the tabs 20 in the different segments 30, the requirements of the device performance in the process of roller leveling the tabs 20 can be lowered, and the device can be used to roller level the tabs 20 efficiently and accurately, thereby improving the technical problems of overlapping and misalignment of the tabs 20 in the process of roller leveling the tabs 20.

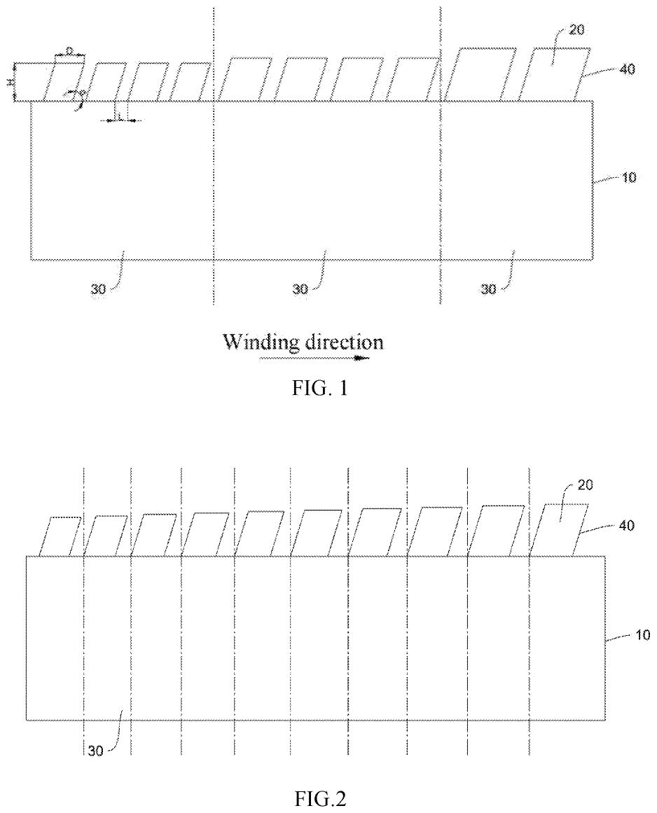

Referring to FIG. 1, the electrode sheet 10 may be divided into a plurality of segments 30, such that each segment 30 of the plurality of segments 30 has several tabs 20. For example, there are four tabs 20, ten tabs 20, fifty tabs 20, one hundred tabs 20, etc., within each segment 30. For a segment 30 of a certain length, the greater the number of tabs 20 in the segment 30 is, the more toroidal an end face structure that the tabs 20 can form after folded, which reduces overlapping and misalignment of the tabs 20 upon roller leveling, thereby facilitating the elevation of the end face flatness. However, the greater the number of the tabs 20 is, the more times the tabs 20 are cut in a process of manufacturing the tabs 20, and the more times the tabs 20 are folded, and the higher the difficulty of molding is. At the same time, an increase in the number of cuts causes a decrease in production efficiency and an increase in the metal debris, which may result in an increase in the defective rate of the battery. Therefore, the number of the tabs 20 contained in each segment 30 can be reasonably selected according to a current manufacturing process level and a preset manufacturing cost, so that the production process and the defect rate are balanced and the optimal production mode is ensured.

For the at least one tab 20 located in the same segment 30, each tab 20 has the same width and the same height. That is, any two tabs 20 in the same segment 30 would have the same width and the same height. For tabs 20 respectively located in different segments 30, the tabs 20 have different widths and/or different heights. That is, any two tabs 20 respectively located in the different segments 30 would have different widths and/or different heights.

Referring to FIG. 2, the electrode sheet 10 may be divided into a plurality of segments 30, so that each segment 30 of the plurality of segments 30 has only one tab 20.

Since the electrode sheet 10 is wound to form a winding core, the electrode sheet 10 is mainly used in a cylindrical battery. The electrode sheet 10 may be a positive electrode sheet or a negative electrode sheet. Correspondingly, the tab 20 may be a positive tab or a negative tab.

Where, the first direction may be a winding direction in which the electrode sheet 10 is wound to form the winding core. The winding direction is a direction in which the electrode sheet 10 is gradually wound to form the winding core. In a process of winding the electrode sheet 10, a radius of the formed winding core is gradually increased. A direction perpendicular to the winding direction is a width direction of the electrode sheet 10 or a height direction of the formed winding core.

The tabs 20 respectively located in the different segments 30 may have different widths and the same height. Alternatively, the tabs 20 may have different heights and the same width. Alternatively, the tabs 20 may have different widths and different heights.

In some embodiments, the widths and heights of the tabs 20 respectively located in the different segments 30 are gradually increased along the winding direction. As a result, inner sides of the tabs 20 are substantially flush with each other after the tabs 20 being bent. Each tab 20 is bent toward a center direction of the winding core, and the radius of the winding core may increase as the electrode sheet 10 is gradually wound. A tab 20 being in the larger radius position of the winding core requires a longer distance after the tab 20 is bent to enable the inner side of the tab 20 to be flush with the inner side of another tab 20 being in the smaller radius position of the winding core. As a result, the heights of the tabs 20 respectively located in the different segments 30 are gradually increased to compensate for a position offset caused by the increase in the radius of the winding core and to ensure that the inner sides of the tabs 20 are substantially flush with each other. As a result, each of the tabs 20 is substantially formed in a cylindrical structure of a circular ring after being bent.

In some embodiments, the electrode sheet 10 has only one tab 20 within each segment 30 along the winding direction, and the widths and heights of the tabs 20 of the electrode sheet 10 are gradually increased along the winding direction. As a result, inner sides of the tabs 20 are substantially flush with each other after the tabs 20 being bent.

In some embodiments, the widths and heights of the tabs 20 respectively located in the different segments 30 may be changed irregularly along the winding direction. For example, the widths and heights of the tabs 20 respectively located in the different segments 30 may be increased at first and then decreased, or decreased at first and then increased, etc. Even if the widths and the heights of the tabs 20 are changed irregularly, it is still possible to reduce overlapping and interference of the tabs 20 with each other.

Referring to FIG. 1, all the tabs 20 are provided at intervals and a spacing between every two adjacent tabs 20 is L.

In some embodiments, for tabs 20 within the same segment 30, a spacing between every two adjacent tabs 20 is the same. For the tabs 20 respectively located in different segments 30, the spacing between every two adjacent tabs 20 is different from each other.

In some embodiments, for all the tabs 20 of the electrode sheet 10, a spacing between every two adjacent tabs 20 is the same.

In some embodiments, for all the tabs 20 of the electrode sheet 10, a spacing between every two adjacent tabs 20 is different from each other.

Where, 0<L≤2 mm. For example, L may be 0.05 mm, 0.1 mm, 0.2 mm, 0.5 mm, 1 mm, 1.8 mm, 2 mm, or any numerical value between any two of the above values.

In some embodiments, the tab 20 is a component formed by performing a die cutting process or a laser cutting process on the electrode sheet 10. For tabs 20 having different heights or widths, respective cutting parameters can be adjusted during die cutting or laser cutting of the electrode sheet 10.

In some embodiments, a shape of the tab 20 is set as a parallelogram including two oppositely disposed beveled edges 40, where either of the beveled edges 40 is disposed at an included angle with the electrode sheet 10. For a tab 20 in the same segment 30, either of the beveled edges 40 of the tab 20 is disposed at the same included angle with the electrode sheet 10, and for each of tabs 20 respectively located in different segments 30, either of the beveled edges 40 of the each of the tabs 20 is at the same included angle or different angle with the electrode sheet 10.

Shaping the tab 20 in a parallelogram shape facilitates die-cutting molding of the tab 20 and reduce the degree of deformation of tabs 20 when the tabs 20 are bent, improving the flatness and uniformity of an end face of the tabs 20. This shape design of the tabs 20, in combination with its width design and height design, lower the requirements demanded of the equipment used in a roller leveling process for making the tabs 20, and improve the shape of the end face of the tabs 20 being formed through that process.

In a process of die cutting the electrode sheet 10 to form the tab 20, the electrode sheet 10 is in a state of continuous horizontal movement. Due to a relative movement of the electrode sheet 10 with respect to the cut laser light, the laser light can cut the electrode sheet 10 directly to obtain a beveled edge 40. As a result, the formation of the electrode sheet 10 is facilitated, which simplifies the molding process of the electrode sheet 10.

Since the tab 20 has a shape of a parallelogram, the beveled edge 40 of the tab 20 is disposed at an angle with a side edge of the electrode sheet 10. For a tab 20 in the same segment 30, an included angle is formed between the beveled edge 40 of the tab and the electrode sheet 10, and those included angles are the same as each other. That is, an included angle between the beveled edge 40 of each of all the tabs 20 located in the same segment 30 and the electrode sheet 10 is the same. In addition, all the tabs 20 located in the same segment 30 have the same height and the same width, and all the tabs 20 located in the same segment 30 have the same shape.

In some embodiments, for tabs 20 respectively located in different segments 30, an included angle between the beveled edge 40 of each of the tabs 20 and the electrode sheet 10 is different from each other. Specifically, the included angle between the beveled edge 40 of each of the tabs 20 and the electrode sheet 10 is gradually increased along the winding direction.

In some embodiments, for tabs 20 respectively located in different segments 30, an included angle is formed between the beveled edge 40 of each tab 20 and the electrode sheet 10, and those included angles are all the same as each other.

Based on the shape design of the tabs 20 in each segment 30 and the change in the angle between the beveled edge 40 and the electrode sheet 10, it is possible to make the end face of the tabs 20 flatter after the tabs 20 are bent. Each of the tabs 20 can be enclosed to substantially form a cylindrical structure of a circular ring after being bent. Meanwhile, cases of overlapping and interference of the tabs 20 can be reduced, the degree of deformation of the tabs 20 caused by excessive internal stress in a bending process of the tabs 20 can be reduced, and the flatness and uniformity of the end face of the tabs 20 can be improved.

Based on the shape of the tab 20 being the parallelogram that, for the tabs 20 in the same segment 30, the tabs 20 have the same width and the same height, and an included angle is formed between the beveled edge 40 of each of the tabs 20 and the electrode sheet 10, and those included angles are all the same as each other. For the tabs 20 respectively located in the different segments 30, the tabs 20 have different widths and/or different heights, and the included angle between the beveled edge 40 of each of the tabs 20 and the electrode sheet 10 is the same as each other or different from each other. The tabs 20 on the electrode sheet 10 have several forms, respectively, as follows.

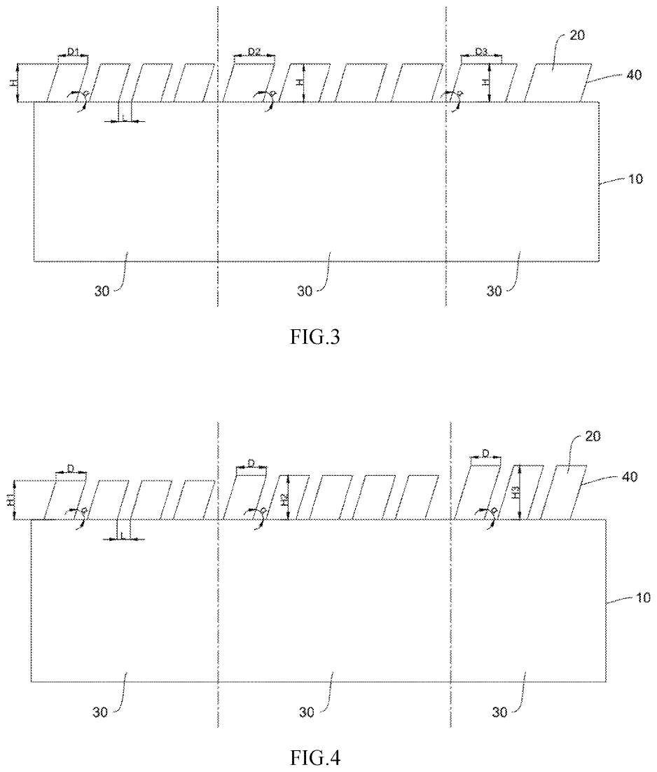

Form 1: referring to FIG. 3, for the tabs 20 in the same segment 30, the tabs 20 have the same width and the same height, and the included angle is formed between the beveled edge 40 of each of the tabs 20 and the electrode sheet 10, and those included angles are all the same as each other. For the tabs 20 respectively located in the different segments 30, the tabs 20 have different widths, i.e., D₁, D₂, D₃ . . . . Dₙ. The tabs 20 respectively located in the different segments 30 have the same height, i.e., H. The included angle between the beveled edge 40 of each of the tabs 20 respectively located in the different segments 30 and the electrode sheet 10 is the same, i.e., a.

Form 2: referring to FIG. 4, for the tabs 20 in the same segment 30, the tabs 20 have the same width and the same height, and the included angle is formed between the beveled edge 40 of each of the tabs 20 and the electrode sheet 10, and those included angles are all the same as each other. For the tabs 20 respectively located in the different segments 30, the tabs 20 have the same width, i.e., D. The tabs 20 respectively located in the different segments 30 have different heights, i.e., H₁, H₂, H₃ . . . . Hₙ. The included angle between the beveled edge 40 of each of the tabs 20 respectively located in the different segments 30 and the electrode sheet 10 is the same, i.e., a.

Form 3: referring to FIG. 5, for the tabs 20 in the same segment 30, the tabs 20 have the same width and the same height, and the included angle is formed between the beveled edge 40 of each of the tabs 20 and the electrode sheet 10, and those included angles are all the same as each other. For the tabs 20 respectively located in the different segments 30, the tabs 20 have different widths, i.e., D₁, D₂, D₃ . . . . Dₙ. The tabs 20 respectively located in the different segments 30 have different heights, i.e., H₁, H₂, H₃ . . . . Hₙ. The included angle between the beveled edge 40 of each of the tabs 20 respectively located in the different segments 30 and the electrode sheet 10 is the same, i.e., a.

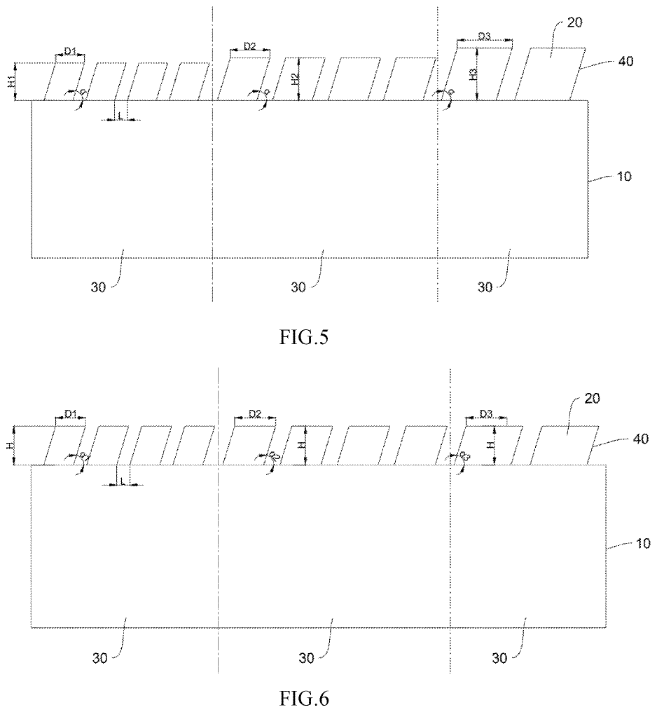

Form 4: referring to FIG. 6, for the tabs 20 in the same segment 30, the tabs 20 have the same width and the same height, and the included angle is formed between the beveled edge 40 of each of the tabs 20 and the electrode sheet 10, and those included angles are all the same as each other. For the tabs 20 respectively located in the different segments 30, the tabs 20 have different widths, i.e., D₁, D₂, D₃ . . . . Dₙ. The tabs 20 respectively located in the different segments 30 have the same height, i.e., H. The included angle between the beveled edge 40 of each of the tabs 20 respectively located in the different segments 30 and the electrode sheet 10 is different, i.e., α₁, α₂, α₃, . . . αₙ.

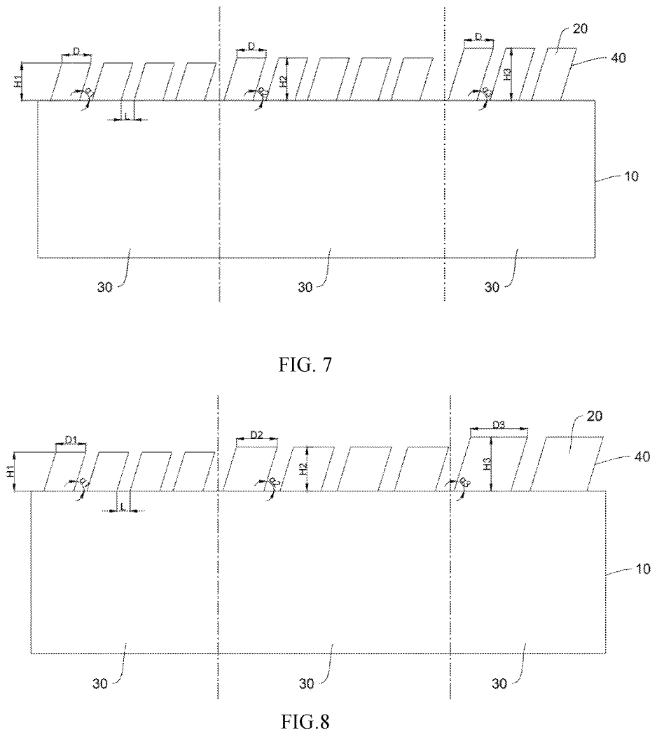

Form 5: referring to FIG. 7, for the tabs 20 in the same segment 30, the tabs 20 have the same width and the same height, and the included angle is formed between the beveled edge 40 of each of the tabs 20 and the electrode sheet 10, and those included angles are all the same as each other. For the tabs 20 respectively located in the different segments 30, the tabs 20 have the same width, i.e., D. The tabs 20 respectively located in the different segments 30 have different heights, i.e., H₁, H₂, H₃ . . . . Hₙ. The included angle between the beveled edge 40 of each of the tabs 20 respectively located in the different segments 30 and the electrode sheet 10 is different, i.e., α₁, α₂, α₃, . . . . Un.

Form 6: referring to FIG. 8, for the tabs 20 in the same segment 30, the tabs 20 have the same width and the same height, and the included angle is formed between the beveled edge 40 of each of the tabs 20 and the electrode sheet 10, and those included angles are all the same as each other. For the tabs 20 respectively located in the different segments 30, the tabs 20 have different widths, i.e., D₁, D₂, D₃ . . . . Dₙ. The tabs 20 respectively located in the different segments 30 have different heights, i.e., H₁, H₂, H₃ . . . . Hₙ. The included angle between the beveled edge 40 of each of the tabs 20 respectively located in the different segments 30 and the electrode sheet 10 is different, i.e., α₁, α₂, α₃, . . . αₙ.

Where, the number of the tabs 20 in each segment 30 can be reasonably selected based on different battery models and different production conditions. For a segment 30 having a certain length that the greater the number of tabs 20 in the segment 30, the more toroidal an end face structure that the tabs 20 can form after folded, the more advantageous it is for improving the problem of overlapping and misalignment of the tabs 20 upon roller leveling, thereby facilitating the elevation of the end face flatness. However, the more the number of the tabs 20 is, the more times the tabs 20 are cut in a process of manufacturing the tabs 20, and the more times the tabs 20 are folded, and the difficulty of molding is increased. At the same time, an increase in the number of cuts causes a decrease in the production efficiency and an increase in the metal debris, which may result in an increase in the defective rate of the battery. Therefore, the number of the tabs 20 contained in each segment 30 can be reasonably selected according to a current manufacturing process level and a preset manufacturing cost, so that the production process and the defect rate are balanced and the optimal production mode is ensured.

Referring to FIG. 2, in some embodiments, each segment 30 has only one tab 20, and along the winding direction, the width of the tab 20 is gradually increased, the height of the tab 20 is gradually increased, and the included angle between the beveled edge 40 of the tab 20 and the electrode sheet 10 is gradually increased.

Because there is only one tab 20 in each segment 30, the shape of the tab 20 is gradually changed along the winding direction. Specifically, the width of the tab 20 is gradually increased, the height of the tab 20 is gradually increased, and the included angle between the beveled edge 40 of the tab 20 and the electrode sheet 10 is gradually increased.

Each tab 20 is bent toward a center direction of the winding core, and the radius of the winding core may increase as the electrode sheet 10 is gradually wound. A tab 20 being in the larger radius position of the winding core requires a longer distance after the tab 20 being bent to enable the inner side of the tab 20 to be flush with the inner side of another tab 20 being in the smaller radius position of the winding core. As a result, the heights of the tabs 20 in the different segments 30 are gradually increased to compensate for a position offset caused by the increase in the radius of the winding core and to ensure that the inner sides of the tabs 20 are substantially flush with each other. In addition, cases of overlapping and interference of the tabs 20 can be reduced, the degree of deformation of the tabs 20 caused by excessive internal stress in a bending process of the tabs 20 can be reduced, and the flatness and uniformity of the end face of the tabs 20 can be improved.

The present embodiment provides a winding core. The winding core is formed by winding the electrode sheet. Where the first direction is a direction in which the electrode sheet is wound.

In the present embodiment, the electrode sheet 10 is divided into the plurality of segments 30, so that the tabs 20 in the same segment 30 have the same width and the same height and the tabs 20 in different segments 30 have different widths and/or different heights. Based on different designs of the widths and the heights of the tabs 20 in the different segments 30, the requirements of the device performance in the process of roller leveling the tabs 20 can be lowered, and the device can be used to roller level the tabs 20 efficiently and accurately, thereby improving the technical problems of overlapping and misalignment of the tabs 20 in the process of roller leveling the tabs 20.

In some embodiments, the width of the tab 20 is positively correlated to a radius of the winding core corresponding to a position of the tab 20 on the winding core.

The radius of the winding core may increase as the electrode sheet 10 is gradually wound to form the winding core. If the width of the tab 20 being in a larger radius position is the same as the width of the tab 20 being in a smaller radius, the number of the tabs 20 in the circumference of the winding core corresponding to the larger radius position may be greater. The greater the number of the tabs 20 is, the more times the tabs 20 are cut in a process of manufacturing, and the more times the tabs 20 are folded, and the difficulty of molding is increased. Meanwhile, an increase in the number of cuts causes a decrease in production efficiency and an increase in metal debris, which may result in an increase in the defective rate of the battery. As a result, the width of the tab 20 is positively correlated to a radius of the winding core corresponding to a position of the tab 20 on the winding core, so that the width of the tab 20 being in a smaller radius position can be made smaller, and the width of the tab 20 being in a larger radius position can be made larger. Accordingly, the widths of the tabs 20 being in different radius positions of the winding core are reasonably arranged, to lower the cutting and folding difficulty of the tabs 20, reduce the possibility of the occurrence of metal debris in the battery, and lower the defect rate of the battery.

In some embodiments, the width of the tab 20 is D, and the radius of the winding core corresponding to the position of the tab 20 on the winding core is R.

A relationship between D and R satisfies: D=A×\sqrt{R}.

Where, A is a constant.

For example, when the radius R of the winding core corresponding to the position of the tab 20 on the winding core is 3 mm and A=0.9, the width of the tab 20 is D=1.56 mm. For example, when the radius R of the winding core corresponding to the position of the tab 20 on the winding core is 5 mm and A=1.1, the width of the tab 20 is D=2.46 mm. For example, when the radius R of the winding core corresponding to the position of the tab 20 on the winding core is 8 mm and A=1.6, the width of the tab 20 is D=4.52 mm.

In some embodiments, A is a constant and affected by the material and thickness of the electrode sheet 10. For example, when the electrode sheet 10 is a copper foil and the thickness of the copper foil is 8 μm, A is in a range of 0.5≤A≤2. For example, A is 0.5, 1, 1.5, 2, or any numerical value within the above range. As another example, when the electrode sheet 10 is an aluminum foil and the thickness of the aluminum foil is 12 μm, A is in a range of 0.5≤A≤2. For example, A is 0.5, 1, 1.5, 2, or any numerical value within the above range.

Both opposite sides of the electrode sheet 10 along the winding direction of the electrode sheet 10 are provided with non-tab 20 regions, so that the tabs 20 are only provided at some radius positions of the winding core. Generally, the radius R of the tab 20 corresponding to the position of the tab 20 on the winding core is in a range of 3 mm≤R≤8.5 mm.

In some embodiments, the height of the tab 20 is positively correlated to a radius of the winding core corresponding to a position of the tab 20 on the winding core.

The radius of the winding core may increase as the electrode sheet 10 is gradually wound to form the winding core. A tab 20 being in the larger radius position of the winding core requires a longer distance after the tab 20 being bent to enable the inner side of the tab 20 to be flush with the inner side of another tab 20 being in the smaller radius position of the winding core. As a result, the height of the tab 20 is positively corelated to a radius of the winding core corresponding to a position of the tab 20 on the winding core, so that the height of the tab 20 being in a smaller radius position can be made shorter, and the height of the tab 20 being in a larger radius position can be made greater, so as to ensure that the inner sides of the tabs 20 are substantially flush with each other. As a result, each of the tabs 20 is substantially formed in a cylindrical structure of a circular ring after being bent.

In some embodiments, the height of the tab 20 is H, and the radius of the winding core corresponding to a position of tab 20 on the winding core is R.

A relationship between H and R satisfies:

$$H = B \times \sqrt[3]{R} - \frac{15 ( {d}_{1} + 2 {d}_{2} )}{2} .$$

Where B is a constant, d₁ is a thickness of the electrode sheet 10, and d₂ is a thickness of a separator.

Where, the thickness d₁ of the electrode sheet 10 is in a range of 0.008 mm≤d₁≤0.02 mm. The thickness d₂ of the separator is in a range of 0.05 mm≤d₂≤0.4 mm.

For example, the thickness of the electrode sheet 10 is d₁=0.01 mm, and the thickness of the separator is d₂=0.1 mm. When the radius R of the winding core corresponding to the position of the tab 20 on the winding core is 3 mm and B=2.5, the height of the tab 20 is H=2.03 mm. When the radius R of the winding core corresponding to the position of the tab 20 on the winding core is 5 mm and B=2.2, the height of the tab 20 is H=2.19 mm. When the radius R of the winding core corresponding to the position of the tab 20 on the winding core is 8 mm and B=2, the height of the tab 20 is H=2.43 mm.

In some embodiments, B is a constant and affected by the material and thickness of the electrode sheet 10. For example, when the electrode sheet 10 is a copper foil and the thickness of the copper foil is 8 μm, B is in a range of 1≤B≤3. For example, B is 1, 2, 3, or any numerical value within the above range. As another example, when the electrode sheet 10 is an aluminum foil and the thickness of the aluminum foil is 12 μm, B is in a range of 1≤B≤3. For example, B is 1, 2, 3, or any numerical value within the above range.

In some embodiments, the included angle between the beveled edge 40 of the tab 20 and the electrode sheet 10 is positively correlated to a radius of the winding core corresponding to a position of the tab 20 on the winding core.

The included angle between the beveled edge 40 of the tab 20 being in a smaller radius position and the electrode sheet 10 is smaller, and the included angle between the beveled edge 40 of the tab 20 being in a larger radius position and the electrode sheet 10 is larger. That is, in the direction of winding, the shape of the tab 20 may gradually approach a rectangle.

In some embodiments, the width of the tab 20 is D, the included angle between the beveled edge 40 and the electrode sheet 10 is α, and the radius of the winding core corresponding to the position of the tab 20 on the winding core is R.

A relationship between D, α, and R satisfies:

$$α = 90 - C \times \frac{180 \cdot D}{π \cdot R} .$$

Where, C is a constant.

A method for calculating the width D of the tab also uses D=A×\sqrt{R}.

For example, when the radius R of the winding core corresponding to the position of the tab 20 on the winding core is 3 mm, A=0.9, and C=1, the included angle between the beveled edge 40 and the electrode sheet 10 is α=60.2°. For example, when the radius R of the winding core corresponding to the position of the tab 20 on the winding core is 5 mm, A=1.1, and C=0.8, the included angle between the beveled edge 40 and the electrode sheet 10 is α=67.4°. For example, when the radius R of the winding core corresponding to the position of the tab 20 on the winding core is 8 mm, A=1.6, and C=0.4, the included angle between the beveled edge 40 and the electrode sheet 10 is α=77°.

In some embodiments, C is a constant and affected by the material and thickness of the electrode sheet 10. For example, when the electrode sheet 10 is a copper foil and the thickness of the copper foil is 8 μm, C is in a range of 0.1≤C≤2. For example, C is 0.1, 0.5, 1, 2, or any numerical value within the above range. As another example, when the electrode sheet 10 is an aluminum foil and the thickness of the aluminum foil is 12 μm, C is in a range of 0.1≤C≤2. For example, C is 0.1, 0.5, 1, 2, or any numerical value within the above range.

In some embodiments, each segment 30 has at least two tabs 20, and for the tabs 20 in the same segment 30, the width and the height of each of all the tabs 20 in the segment 30 and the included angle between the beveled edge 40 of the tab 20 and the electrode sheet 10 are calculated from a radius of the winding core corresponding to a position of a tab 20 located at an intermediate position of the segment 30 on the winding core.

Based on each segment 30 having at least two tabs 20, after the segment 30 is wound, the tabs 20 on the segment 30 may be in different radius positions of the winding core. If the width and the height of each of the tabs 20 and the included angle between the beveled edge 40 of the tab 20 and the electrode sheet 10 are calculated from respective radius of the winding core corresponding to a position of the tab 20 on the winding core, the width and the height of the tab 20 in the segment 30 and the included angle between the beveled edge 40 and the electrode sheet 10 may be inconsistent. As a result, the width and the height of each of all the tabs 20 in the segment 30 and the included angle between the beveled edge 40 of the tab 20 and the electrode sheet 10 are calculated by selecting a tab 20 at an intermediate position of the segment 30 as a reference.

In some embodiments, each segment 30 includes an odd number of tabs 20, and the width and the height of each of all the tabs 20 in the segment 30 and the included angle between the beveled edge 40 of the tab 20 and the electrode sheet 10 are calculated by directly selecting a radius of the winding core corresponding to a position of a tab 20 located at an intermediate position of the segment 30 on the winding core as a reference.

For example, if each segment 30 includes 11 tabs 20, and the width and the height of each of all the tabs 20 in the segment 30 and the included angle between the beveled edge 40 of the tab 20 and the electrode sheet 10 are calculated by selecting a radius of the winding core corresponding to a position of sixth tab 20 on the winding core as a reference. For example, if each segment 30 includes 101 tabs 20, and the width and the height of each of all the tabs 20 in the segment 30 and the included angle between the beveled edge 40 of the tab 20 and the electrode sheet 10 are calculated by selecting a radius of the winding core corresponding to a position of 51st tab 20 on the winding core as a reference.

In some embodiments, each segment 30 includes an even number of tabs 20, and the width and the height of each of all the tabs 20 in the segment 30 and the included angle between the beveled edge 40 of the tab 20 and the electrode sheet 10 are calculated by directly selecting a radius of the winding core corresponding to a position of either of two tabs 20 located at an intermediate position of the segment 30 on the winding core as a reference. The radius of the winding core corresponding to the position of either of the two tabs 20 located at the intermediate position does not differ much or is even the same as each other. Thus, selecting either radius of the winding core as a reference may also substantially reflect an average of the radiuses corresponding to the positions of all the tabs 20 in the segment 30 on the winding core.

For example, if each segment 30 includes 10 tabs 20, and the width and the height of each of all the tabs 20 in the segment 30 and the included angle between the beveled edge 40 of the tab 20 and the electrode sheet 10 are calculated by selecting a radius of the winding core corresponding to a position of fifth tab 20 or sixth tab 20 on the winding core as a reference. For example, if each segment 30 includes 100 tabs 20, and the width and the height of each of all the tabs 20 in the segment 30 and the included angle between the beveled edge 40 of the tab 20 and the electrode sheet 10 are calculated by selecting a radius of the winding core corresponding to a position of 50th tab 20 or 51st tab 20 on the winding core as a reference.

The present embodiment provides a cylindrical battery. The cylindrical cell includes an electrode sheet 10.

In the present embodiment, the electrode sheet 10 is divided into the plurality of segments 30, so that the tabs 20 in the same segment 30 have the same width and the same height and the tabs 20 in different segments 30 have different widths and/or different heights. Based on different designs of the widths and the heights of the tabs 20 in the different segments 30, the requirements of the device performance in the process of roller leveling the tabs 20 can be lowered, and the device can be used to roller level the tabs 20 efficiently and accurately, thereby improving the technical problems of overlapping and misalignment of the tabs 20 in the process of roller leveling the tabs 20.

The present embodiment provides a battery pack. The battery pack includes the cylindrical battery.

In the present embodiment, the electrode sheet 10 is divided into the plurality of segments 30, so that the tabs 20 in the same segment 30 have the same width and the same height and the tabs 20 in different segments 30 have different widths and/or different heights. Based on different designs of the widths and the heights of the tabs 20 in the different segments 30, the requirements of the device performance in the process of roller leveling the tabs 20 can be lowered, and the device can be used to roller level the tabs 20 efficiently and accurately, thereby improving the technical problems of overlapping and misalignment of the tabs 20 in the process of roller leveling the tabs 20.

What is claimed is:

1. An electrode sheet comprising:
a plurality of tabs disposed at intervals along one side of the electrode sheet,
wherein the electrode sheet comprising at least two segments arranged along a first direction, each of the at least two segments comprising at least one tab of the plurality of tabs, wherein a length of each tab in the first direction defines a width of the tab, and a length of the each tab in a second direction perpendicular to the first direction defines a height of the tab, wherein for tabs located within a same one of the at least two segment, the tabs have a same width and a same height, and for tabs located in different segments of the at least two segments, the tabs have at least one of different widths or different heights.

2. The electrode sheet of claim 1, wherein each tab has a parallelogram shape comprising two oppositely disposed beveled edges, wherein either of the beveled edges is disposed at an included angle with the electrode sheet, and for each of the at least one tab in the same segment, an included angle between the beveled edge of the tab and the electrode sheet is the same.

3. The electrode sheet of claim 2, wherein each of the at least two segments has only one of the plurality of tabs, and in the first direction, the width of the tab is gradually increased, the height of the tab is gradually increased, and the included angle between the beveled edge of the tab and the electrode sheet is gradually increased.

4. A winding core formed by winding an electrode sheet, the electrode sheet being provided with a plurality of tabs disposed at intervals along one side of the electrode sheet, wherein the electrode sheet comprising at least two segments arranged along the first direction, each of the at least two segments comprising at least one tab of the plurality of tabs, wherein the length of each tab in the first direction defines the width of the tab, and the length of the each tab in the second direction perpendicular to the first direction defines the height of the tab, wherein for tabs located within the same one of the at least two segment, the tabs have the same width and the same height, and for tabs located in different segments of the at least two segments, the tabs have at least one of different widths or different heights, and wherein the electrode sheet is wound in the first direction.

5. The winding core of claim 4, wherein the width of each tab is positively correlated to a radius (R) of the winding core corresponding to a position of the tab on the winding core.

6. The winding core of claim 5, wherein the width of the tab is D, and the radius of the winding core corresponding to the position of the tab on the winding core is R,
wherein a relationship between D and R satisfies: D=A×\sqrt{R},
wherein, A is a constant.

7. The winding core of claim 4, wherein the height of each tab is positively correlated to a radius (R) of the winding core corresponding to a position of the tab on the winding core.

8. The winding core of claim 7, wherein the height of the tab is H, and the radius of the winding core corresponding to the position of the tab on the winding core is R,
wherein a relationship between H and R satisfies:
$$H = B \times \sqrt[3]{R} - \frac{15 ( {d}_{1} + 2 {d}_{2} )}{2} ,$$
wherein B is a constant, d₁ is a thickness of the electrode sheet, and d₂ is a thickness of a separator.

9. The winding core of claim 4, wherein an included angle between a beveled edge of the tab and the electrode sheet is positively correlated to a radius (R) of the winding core corresponding to a position of the tab on the winding core.

10. The winding core of claim 9, wherein the width of the tab is D, the included angle between the beveled edge and the electrode sheet is α, and the radius of the winding core corresponding to the position of the tab on the winding core is R,
wherein a relationship between D, α, and R satisfies:
$$α = 90 - C \times \frac{180 \cdot D}{π \cdot R} ,$$
wherein, C is a constant.

11. The winding core of claim 4, wherein each of the at least two segments has at least two of the plurality of tabs, and for each of the tabs in the same segment, the width and the height of each of the tabs in the segment and the included angle between the beveled edge of the tab and the electrode sheet are calculated from a radius of the winding core corresponding to a position of a tab located at an intermediate position of the segment on the winding core.

12. The winding core of claim 5, wherein each of the at least two segments has at least two of the plurality of tabs, and for each of the tabs in the same segment, the width and the height of each of the tabs in the segment and the included angle between the beveled edge of the tab and the electrode sheet are calculated from a radius of the winding core corresponding to a position of a tab located at an intermediate position of the segment on the winding core.

13. The winding core of claim 6, wherein each of the at least two segments has at least two of the plurality of tabs, and for each of the tabs in the same segment, the width and the height of each of the tabs in the segment and the included angle between the beveled edge of the tab and the electrode sheet are calculated from a radius of the winding core corresponding to a position of a tab located at an intermediate position of the segment on the winding core.

14. The winding core of claim 7, wherein each of the at least two segments has at least two of the plurality of tabs, and for each of the tabs in the same segment, the width and the height of each of the tabs in the segment and the included angle between the beveled edge of the tab and the electrode sheet are calculated from a radius of the winding core corresponding to a position of a tab located at an intermediate position of the segment on the winding core.

15. The winding core of claim 8, wherein each of the at least two segments has at least two of the plurality of tabs, and for each of the tabs in the same segment, the width and the height of each of the tabs in the segment and the included angle between the beveled edge of the tab and the electrode sheet are calculated from a radius of the winding core corresponding to a position of a tab located at an intermediate position of the segment on the winding core.

16. The winding core of claim 9, wherein each of the at least two segments has at least two of the plurality of tabs, and for each of the tabs in the same segment, the width and the height of each of the tabs in the segment and the included angle between the beveled edge of the tab and the electrode sheet are calculated from a radius of the winding core corresponding to a position of a tab located at an intermediate position of the segment on the winding core.

17. The winding core of claim 10, wherein each of the at least two segments has at least two of the plurality of tabs, and for each of the tabs in the same segment, the width and the height of each of the tabs in the segment and the included angle between the beveled edge of the tab and the electrode sheet are calculated from a radius of the winding core corresponding to a position of a tab located at an intermediate position of the segment on the winding core.

18. A cylindrical battery, comprising: a winding core, the winding core formed by winding an electrode sheet, the electrode sheet being provided with a plurality of tabs disposed at intervals along one side of the electrode sheet, wherein the electrode sheet comprising at least two segments arranged along the first direction, each of the at least two segments comprising at least one tab of the plurality of tabs, wherein the length of each tab in the first direction defines the width of the tab, and the length of the each tab in the second direction perpendicular to the first direction defines the height of the tab, wherein for tabs located within the same one of the at least two segment, the tabs have the same width and the same height, and for tabs located in different segments of the at least two segments, the tabs have at least one of different widths or different heights, and wherein the electrode sheet is wound in the first direction.

19. The cylindrical battery of claim 18, wherein the width of each tab is positively correlated to a radius of the winding core corresponding to a position of the tab on the winding core.

20. A battery pack, comprising: the cylindrical battery of claim 18.
